(19) United States
(12) Patent Application Publication
(10) Pub. No.: US 2007/0235384 A1
(43) Pub. Date: Oct. 11, 2007

(54) FUEL FILTERS

(75) Inventors: Toshihide OKU, Aichi-ken (JP); Tetsuya HARA, Aichi-ken (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 11/695,869

(22) Filed: Apr. 3, 2007

(30) Foreign Application Priority Data
Apr. 7, 2006 (JP) 2006-105999

(51) Int. Cl. B01D 35/28

(52) U.S. Cl. 210/456; 210/435

(57) ABSTRACT

A fuel filter has a filter case and a filter element. The filter case defines a filtration chamber with a fuel inlet and a fuel outlet. The filter element is adapted to filter the fuel. The filter element is disposed within the filtration chamber and divides the filtration chamber into a first section on the side of the fuel outlet and a second section on the side of the fuel outlet. A control device controls the flow of the fuel within the first section, so that the fuel can flow within the first section along substantially the entire filter element.

This application claims priority to Japanese patent application serial number 2006-105999, the contents of which are incorporated herein by reference.

### BACKGROUND OF THE INVENTION

1. Field of the Invention

The present invention relates to fuel filters for removing foreign materials contained a fuel.

2. Description of the Related Art

A known fuel filter is shown in FIGS. 15 and 16. A fuel filter 109 shown in FIGS. 15 and 16 generally includes a filter case 116 and a filter element 126. The filter case 116 has a substantially cylindrical configuration and includes a hollow space formed therein for receiving a fuel pump (not shown). A case body 116A and a cover 123 constitute the filter case 116. A filtration chamber 121 is defined within the case body 116A. The filtration chamber 121 has an open upper end and has a substantially C-shape configuration as viewed from a plan view. The cover 123 is attached to close the upper open end of the filtration chamber 121. The cover 123 has an inlet port 115 and an outlet port 112. Therefore, fuel discharged from a fuel discharge port (not shown) of the fuel pump can flow into the filtration chamber 121 via the inlet port 115. After filtration by the filter element 126, the fuel can flow into a fuel deliver channel (not shown) via the outlet port 112.

In general, the filter element 126 is formed of a non-woven fabric that is folded soon to be pleated. The filter element 126 has a substantially semi-cylindrical tubular configuration. A metal plate 125 is disposed on the inner circumferential side of the filter element 126. Upper and lower end plates 133 and 129 are respectively joined to the upper and lower surfaces of the filter element 126. The metal plate 125 and the filter element 126 are disposed within the filtration chamber 121 of the filter case 116. The lower end plate 129 is joined to the bottom wall of the filtration chamber 121. The upper end plate 133 is joined to the top wall of the filtration chamber 121. The circumferential ends of the filter element 126 is secured to opposite circumferential end walls 116a and 116b of the filtration chamber 121. Therefore, the filter element 126 divides the filtration chamber 121 into an outer peripheral side section (dirty side section) communicating with the inlet port 115 of the filter case 116 and an inner peripheral side section (clean side section) communicating with the outlet port 112. Circumferential grooves 134 are formed in the metal plate 125 in order to allow the flow of the fuel toward the outlet port 113, even in the event that ridges of triangular folded portions on the inner circumferential side of the filter element 126 have closely contacted with the metal plate 125.

According to the arrangement of the fuel filter 109, the fuel discharged from the discharge port of the fuel pump can flow into the outer peripheral side section of the filtration chamber 121 via the inlet port 115. The fuel can be filtered as it passes through the fitter element 126 and flows into the inner peripheral side section of the filtration chamber 121. The filter can further flow into the fuel delivery channel via the outlet port 112, so that the fuel can be supplied to an internal combustion engine (not shown).

The known fuel filter described above is disclosed, for example, in Japanese Laid-Open Patent Publication No. 10-43513.

However, with the known fuel filter 109, the fuel that has flown into the outer peripheral section (i.e., dirty side section) of the filtration chamber 121 via the inlet port 115 cannot reach the entire surface on the outer peripheral side (i.e., the inflow side of the fuel) of the filter element 126. Thus, the fuel flows within the outer peripheral side section of the filtration chamber 121 without control but depending only on factors including the amount of flow of the fuel discharged from the fuel pump and the fuel pressure. For this reason, the fuel tends to flow along the shortest route from the inlet port 115 to the outlet port 112. This means that the fuel intensively flows through a portion of the filter element 126 located on the shortest route from the inlet port 115 to the outlet port 112. Therefore, such a portion of the filter element 126 may be rapidly clogged to increase the loss of pressure. As a result, the filtration performance may be rapidly degraded.

Thus, there is a need in the art for a fuel filter that can improve the filtration performance.

### SUMMARY OF THE INVENTION

One aspect according to the present invention includes a filter case defining a filtration chamber with a fuel inlet and a fuel outlet, and a filter element for filtering the fuel. The filter element is disposed within the filtration chamber and divides the filtration chamber into a first section on the side of the fuel outlet and a second section on the side of the fuel outlet. The filter element has a first side opposing to the first section and a second side opposing to the second section. The fuel filter further includes a guide device disposed within the first section and arranged and constructed to provide a flow of the fuel within the first section along substantially the entire filter element.

With this arrangement, the fuel can enter the fuel inlet of the filter case and flow into the first section of the filtration chamber. The fuel is then filtered by the filter element and flows into the second section of the filtration chamber. The fuel can then flow out of the filter case via the fuel outlet. Because the guide device is disposed within the first section for providing a flow of the fuel within the first section along substantially the entire filter element, it is possible to prevent the fuel from intensively passing through a portion of the filter element. Therefore, the filter element can be effectively used and the filtration performance can be improved As a result, the life of the fuel filter can be improved and the size of the fuel filter can be minimized.

In one embodiment, the guide device includes a guide projection projecting from an inner wall surface of the first section. The inner wall surface is spaced from the first side of the filter element by a first clearance or distance. With this arrangement, the guide device has a simple construction and can be easily incorporated into the fuel filter.

The guide projection can provide a detour path for the flow of the fuel from the fuel inlet side to the fuel outlet side. Alternatively, the guide projection can provide a meandering path for the flow of the fuel from the fuel inlet side to the fuel outlet side.

Another embodiment according to the present invention includes a fuel filter having a filter case defining a filtration chamber with a fuel inlet and a fuel outlet, and a filter element for filtering the fuel. The filter element is disposed within the filtration chamber and divides the filtration chamber into a first section on the side of the fuel outlet and a second section on the side of the fuel outlet. The filter element has a first side opposing to the first section and a second side opposing to the second section. The first section has an inner wall spaced from the first side of the filter element by a first clearance. The size of the first clearance on the fuel outlet side is smaller than the size of the first clearance on the fuel inlet side.

With this arrangement, it is possible to reduce the loss of pressure of the fuel caused by passing through the filter element from the fuel inlet side to the fuel outlet side within the first section. Therefore, it is possible to realize a flow of the fuel within the first section along substantially the entire filter element. It is possible to prevent the fuel from intensively passing through a portion of the filter element. Therefore, the filter element can be effectively used and the filtration performance can be improved. As a result, the life of the fuel filter can be improved and the size of the fuel filter can be minimized.

In another embodiment, the second section has an inner wall spaced from the second side of the filter element by a second clearance. The size of the second clearance on the fuel outlet side is greater than the size of the second clearance on the fuel inlet side. With this arrangement, the fuel can effectively smoothly flow from the second section to the outlet.

In another embodiment, the filtration chamber has a first width between the inner wall of the first section and the inner wall of the second section. The first width is substantially uniform between the fuel inlet side and the fuel outlet side. The filter element has a second width between the first side and the second side. The second width is substantially uniform between the fuel inlet side and the fuel outlet side.

With this arrangement, for example, by positioning the filter element diagonally within the filtration chamber, it is possible to set the size of the first clearance on the fuel outlet side to be smaller than the size of the first clearance on the fuel inlet side and also to set the size of the second clearance on the fuel outlet side to be greater than the size of the second clearance on the fuel inlet side. Therefore, an existing filter case having a filtration chamber with a uniform width and an existing filter element having a uniform width can be used. The incorporation of the arrangement of the invention does not cause increase in size of the filter case.

### BRIEF DESCRIPTION OF THE DRAWINGS

FIG. 1 is a plan view of a fuel filter according an embodiment of the present invention;

FIG. 2 is a front view of the fuel filter;

FIG. 3 is a cross sectional view taken along line III-III in FIG. 2;

FIG. 4 is a plan view of a fuel filter according to another embodiment of the present invention;

FIG. 5 is a cross sectional view taken along line V-V in FIG. 4;

FIG. 6 is a plan view of a fuel filter according to another embodiment of the present invention;

FIG. 7 is a front view of the fuel filter;

FIG. 8 is a cross sectional view taken along line VIII-VIII in FIG. 7;

FIG. 9 is a plan view of a fuel filter according to another embodiment of the present invention;

FIG. 10 is a front view of the filter;

FIG. 11 is a cross sectional view taken along line XI-XI in FIG. 10.

FIG. 12 is a plan view of a fuel filter according to another embodiment of the present invention;

FIG. 13 is a front view of the filter;

FIG. 14 is a cross sectional view taken along line XIV-XIV in FIG. 13;

FIG. 15 is a cross sectional view of a known fuel filter; and

FIG. 16 is a cross sectional view taken along line XVI-XVI in FIG. 15.

### DETAILED DESCRIPTION OF THE INVENTION

Each of the additional features and teachings disclosed above and below may be utilized separately or in conjunction with other features and teachings to provide improved fuel filters. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

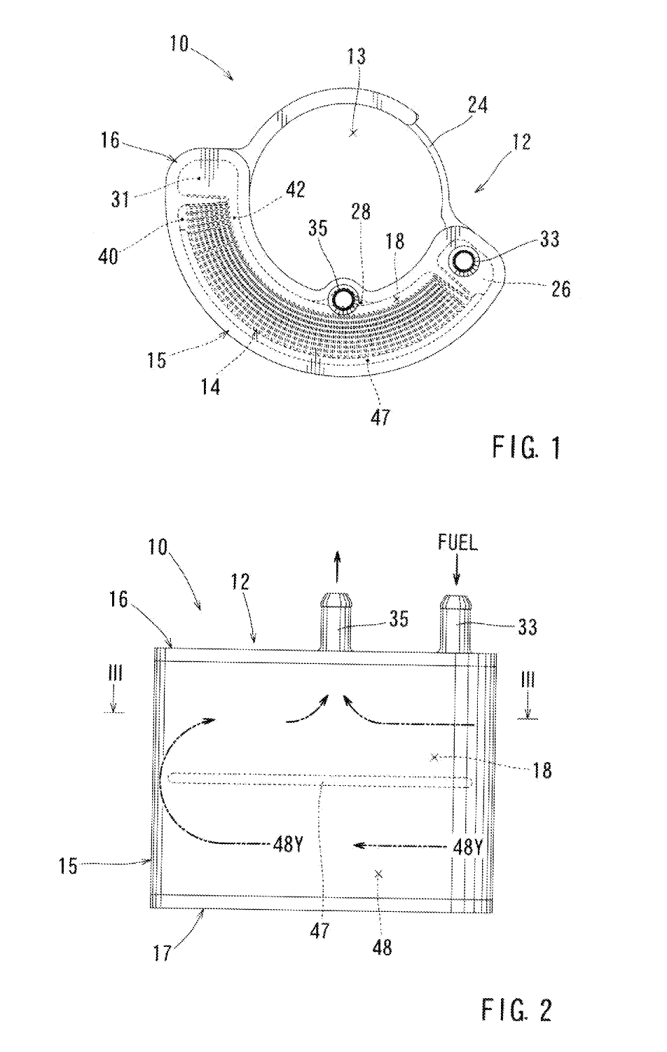

An embodiment according to the present invention will now be described with reference to FIGS. 1 to 3. The first embodiment relates to an in-tank fuel filter that is adapted to be disposed within a fuel tank together with a fuel pump.

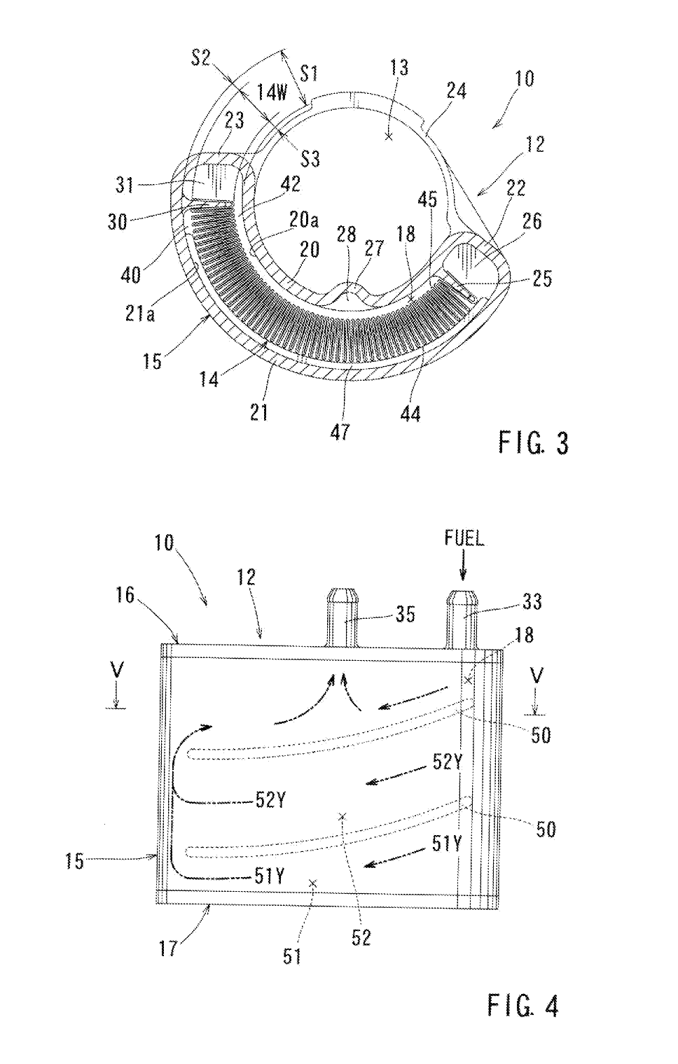

As shown in FIG. 3, a fuel filter 10 according to this embodiment generally includes a filter case 12 and a filter element 14.

As shown in FIG. 1, the filter case 12 has a substantially hollow cylindrical configuration and includes a hollow space 13 formed therein. The hollow space 13 serves as a pump locating region for receiving a fuel pump (not shown). As shown in FIG. 2, the filter case 12 includes a case body 15 as a primarily member, an upper cover 16 for closing an open upper end of the case body 15, and a lower cover 17 for closing an open lower end of the case body 15. The case body 15, the upper cover 16 and the lower cover 17 can respectively be molded by resin.

As shown in FIG. 3, the case body 15 has a substantially hollow cylindrical configuration. A filtration chamber 18 having upper and lower openings is formed within the case body 15 and defines a substantially semi-cylindrical tubular space within the case body 15 along substantially half the circumferential length of the case body 15. The filtration chamber 18 is defined by an inner circumferential wall 20, an outer circumferential wall 21 and a pair of end walls 22 and 23. The inner circumferential wall 20 has a substantially semi-cylindrical tubular configuration in cross section. The outer circumferential wall 21 is coaxial with the inner circumferential wall 20 and is spaced therefrom by a predetermined distance. The pair of end walls 22 and 23 are respectively joined to circumferential ends of the inner and outer circumferential walls 20 and 21 so as to close the opposite ends in the circumferential direction of the filtration chamber 18. The case body 15 has a connecting portion 24 having a substantially semi-cylindrical tubular portion and formed in series with the inner circumferential wall 20, so that the connecting portion 24 and the inner circumferential wall 20 cooperate to define the hollow space 13. A wall surface 20a of the inner circumferential wall 20 and a wall surface 21a of the outer circumferential wall 21 are spaced by a uniform distance S1 along the circumferential length of the filtration chamber 18.

A linear projection 25 is formed on an end portion (right end portion as viewed in FIG. 3) in the circumferential direction of the inner circumferential wall 20. The linear projection 25 is disposed adjacent to the end wall 22 and extends substantially parallel with the end wall 22, so that a fuel inlet region 26 is defined between the liner projection 25 and the end wall 22. The protruding distance of the linear projection 25 is set to be smaller than the distance S1, so that a gap is formed between the linear projection 25 and the outer circumferential wall 21 for allowing the flow of the fuel from the inlet region 26 into an outer circumferential side region of the filtration chamber 18. Further, a depression 27 is formed at a substantially central portion in the circumferential direction of the inner circumferential wall 20 and is depressed radially inwardly toward the hollow space 13. A fuel outlet region 28 is defined by the depression 27 as will be explained later.

A linear projection 30 is formed on an end portion (left end portion as viewed in FIG. 3) in the circumferential direction of the outer circumferential wall 21. The linear projection 30 is disposed adjacent to the end wall 23 and extends substantially parallel with the end wall 23, so that a fuel storage region 26 is defined between the liner projection 30 and the end wall 23. Also, the protruding distance of the linear projection 30 is set to be smaller than the distance S1, so that a gap is formed between the linear projection 30 and the inner circumferential wall 20 for allowing the flow of the fuel from the inner circumferential side region of the filtration chamber 18 into the fuel storage region 26.

As shown in FIG. 2, the upper cover 16 is joined to the upper end of the case body 15 by a suitable means, such as welding and adhesion, so that the upper open end of the filtration chamber 18 is sealingly closed by the upper cover 16. A fuel inlet portion 33 is formed on one end in the circumferential direction of the upper cover 16. A fuel outlet portion 35 is formed on the central portion in the circumferential direction of the upper cover 16 and is positioned on the inner circumferential side of the upper cover 16.

The fuel inlet portion 33 is configured as a pipe that extends upward from the upper cover 16 and provides fluid communication between the inlet region 26 of the filtration chamber 18 and the outside of the filter case 12 (see FIG. 1). A fuel discharge port of the fuel pump (not shown) can be connected to the fuel inlet portion 33 via a suitable pipeline, such as a tube, so that the fuel discharged from the fuel discharge port of the fuel pump can be supplied into the fuel inlet region 26 of the filtration chamber 18 via the fuel inlet portion 33.

Also, the fuel outlet portion 35 is configured as a pipe that extends upward from the upper cover 16 and provides fluid communication between the outlet region 28 of the filtration chamber 18 and the outside of the filter case 12 (see FIG. 1). Opposite ends of a suitable pipeline, such as a tube, can be respectively connected to a fuel delivery channel (not shown) and the fuel outlet portion 35, so that the fuel within the fuel outlet region 28 of the filtration chamber 18 can be supplied to the fuel delivery channel via the fuel outlet portion 35 and further to an internal combustion engine (not shown).

As shown in FIG. 2, the lower cover 17 is joined to the lower end of the case body 15 by a suitable means, such as welding and adhesion, so that the lower open end of the filtration chamber 18 is sealingly closed by the lower cover 17. Otherwise, the lower cover 17 can be integrally formed with the case body 15 to define a bottom wall of the filtration chamber 18.

The filter element 14 will now be described. As shown in FIG. 3, the filter element 14 is formed of suitable filtration material, such as a filter paper and a non-woven fabric, which is folded so as to be pleated, so that the filter element 14 has a substantially rectangular plate-like configuration as a whole. In order to fit the filter element 14 into the filtration chamber 18, the filter element 14 is flexed to have an arc shape as viewed from the upper side One circumferential end (right end as viewed in FIG. 3) of the filter element 14 is engaged with the linear projection 25 of the inner circumferential wall 20 of the filtration chamber 18 and is joined thereto by a suitable means, such as adhesion. Similarly, the other circumferential end (left end as viewed in FIG. 3) of the filter element 14 is engaged with the linear projection 30 of the outer circumferential wall 21 of the filtration chamber 18 and is joined thereto by a suitable means, such as adhesion. The upper end of the filter element 14 is joined to the upper cover 16 (see FIG. 2) by a suitable means, such as welding. Similarly, the lower end of the filter element 14 is joined to the lower cover 17 (see FIG. 2) by a suitable means, such as welding. Therefore, the filter element 14 divides the filtration chamber 18 into a first section 40 located on the outer peripheral side and a second section 42 located on the inner peripheral side (see FIG. 3). The first section 40 includes the inlet region 26 communicating with the inlet portion 33. The second section 42 includes the outlet region 28 communicating with the outlet portion 35 and also includes the fuel storage region 31. The first section 40 may be also referred to as “dirty side section” and the second section 42 may be also referred to as “clean side section.” Thus, an outer peripheral side 44 and an inner peripheral side 45 of the filter element 14 respectively correspond to an inlet side and an outlet side with respect to the filter element 14. The filter element 14 can have a uniform width 14W along the circumferential direction. Here, the width 14W is a distance between a plane on the outer peripheral side 44 and a plane on the inner peripheral side 45. Further, a clearance or distance S2 between the plane of the outer peripheral side 44 of the filter element 18 and the inner wall surface 21a of the first section 40 of the filtration chamber 18 is uniform along the circumferential direction Also, a clearance S3 between the plane of the outer peripheral side 45 of the filter element 18 and the inner wall surface 20a of the second section 42 of the filtration chamber 18 is uniform along the circumferential direction.

Therefore, in operation of the fuel filter 10, the fuel discharged from the fuel discharge port of the fuel pump flows into the first section 40 of the filtration chamber 18 via the fuel inlet portion 33 (see FIG. 2) and the fuel inlet region 26 (see FIG. 3). Then, the fuel within the first section 40 is filtered by the filter element 14 by passing through the filter element in a direction radially inward into the second section 42. Thereafter, the fuel flows from the second section 42 into the fuel delivery channel via the fuel outlet region 28 (see FIG. 3) and the fuel outlet portion 35 (see FIG. 2) so as to be eventually supplied to the internal combustion engine.

As shown in FIGS. 2 and 3, according to the fuel filter 10 of this embodiment, a linear guide projection 47 is formed on the inner wall surface 21a of the outer circumferential wall 21 of the filtration chamber 18 that is spaced from the plane of the outer peripheral side 44 of the filter element 14 by the clearance S2. The guide projection 47 extends in the circumferential direction along the inner wall surface 21a. More specifically, the guide projection 47 extends horizontally at a level of the middle position with respect to the height of the filter element 14 from a first position to a second position. The first position radially opposes the linear projection 25 of the inner circumferential wall 20. The second position is proximal to the linear projection 30 of the outer circumferential wall 30 but does not radially oppose to the linear projection 30. In addition, the protruding distance of the guide projection 47 is substantially the same as the clearance S2, so that the guide projection 47 contacts with or substantially contacts with the outer peripheral side 44 of the filter element 14. The guide projection 47 may be formed integrally with the inner wall surface 21a of the outer circumferential wall 21 or may be formed separately from the outer circumferential wall 21 and joined to the inner wall surface 21a by a suitable means, such as adhesion.

Because of the provision of the guide projection 47, the fuel that has flown into the fuel inlet region 26 flows toward the fuel storage region 31 through the first section 40 of the filtration chamber 18 along upper and lower flow paths separated by the guide projection 47. At the end of the lower flow path, the flow of the fuel is turned upward as indicated by arrow 48Y in FIG. 2 and converges with the flow of the fuel along the upper path. Therefore, the guide projection 47 provides a detour route 48 for the flow of the fuel from the fuel inlet side (i.e., the side of the fuel inlet region 26) to the fuel outlet side (i.e., the side of the fuel outlet region 28). As the fuel flows though the first section 40 in this way, the fuel may pass through the filter element 14 in the radial direction, so that the fuel is filtered and flows into the second section 42.

According to the fuel filter 10 of this embodiment, the guide projection 47 located within the first section 40 of the filtration chamber 18 enables the fuel to flow along substantially the entire outer peripheral side 44 of the filter element 14 opposing to the first section 40. Therefore, it is possible to prevent the fuel from intensively passing through a portion of the filter element 14 (i.e., a portion on the shortest route between the fuel inlet portion 33 to the fuel outlet portion 35). Thus, because the entire filtration area of the filter element 14 can be effectively used, the filtration performance can be improved and it is possible to improve the life of the fuel filter 10 and to reduce the size of the fuel filter 10. Although one guide projection 47 is provided in this embodiment, a plurality of guide projections 47 can be provided to extend parallel with each other in the vertical direction.

Further, by forming the guide projection 47 integrally with the inner wall surface 21a of the first chamber 40 that is spaced from the outer peripheral side 44 of the filter element 14 by the clearance S2, the guide projection 47 can be easily produced.

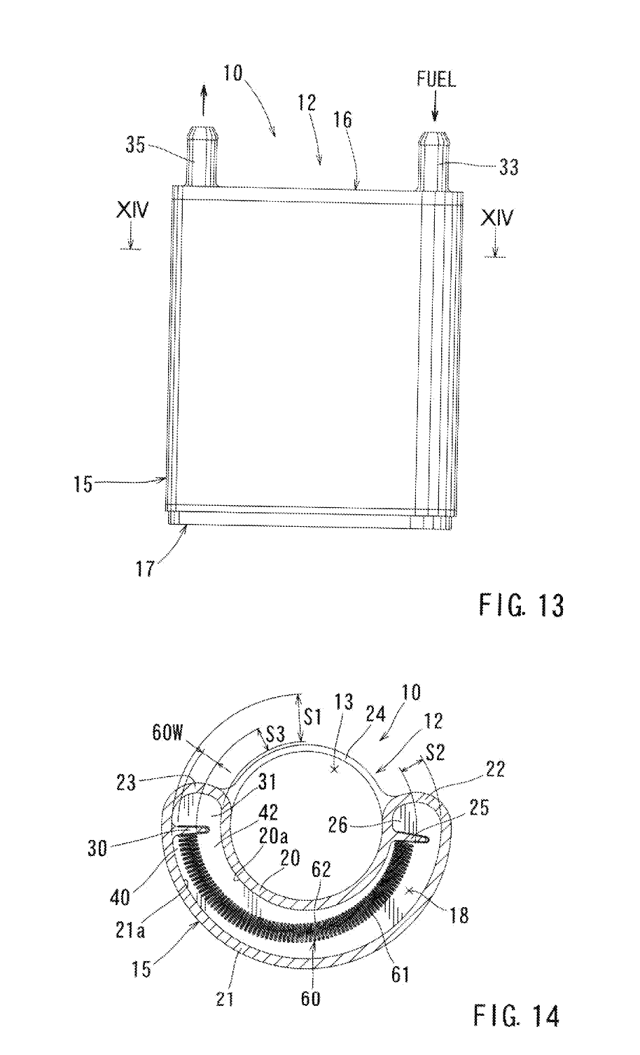

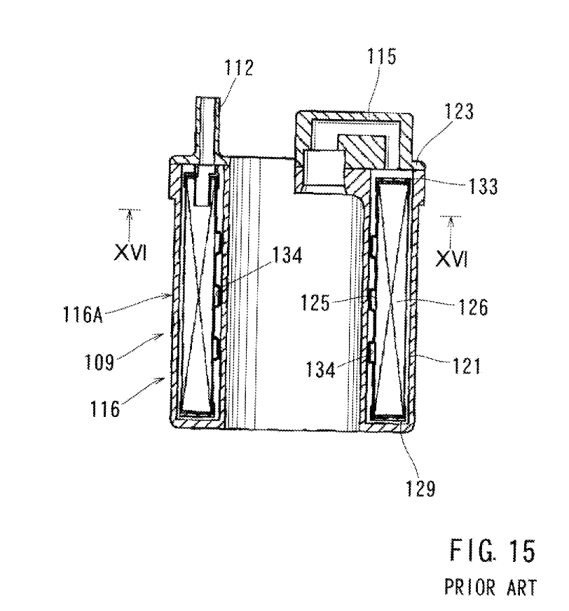

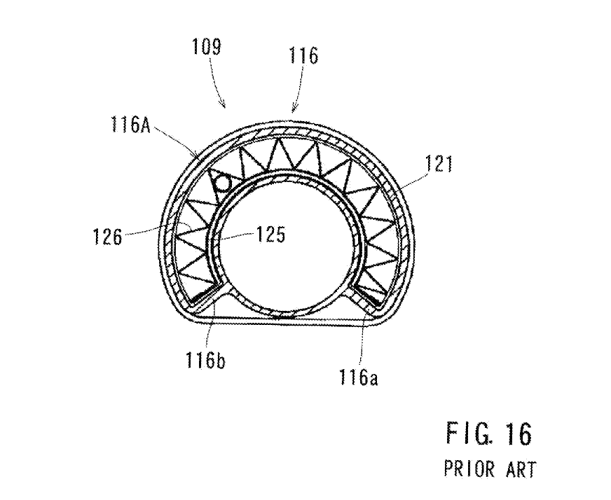

Further embodiments will now be described with reference to FIGS. 4 to 14. These embodiments are modifications of the last embodiment. Therefore, like members are given the same reference numerals as the last embodiment and the description will not be repeated.

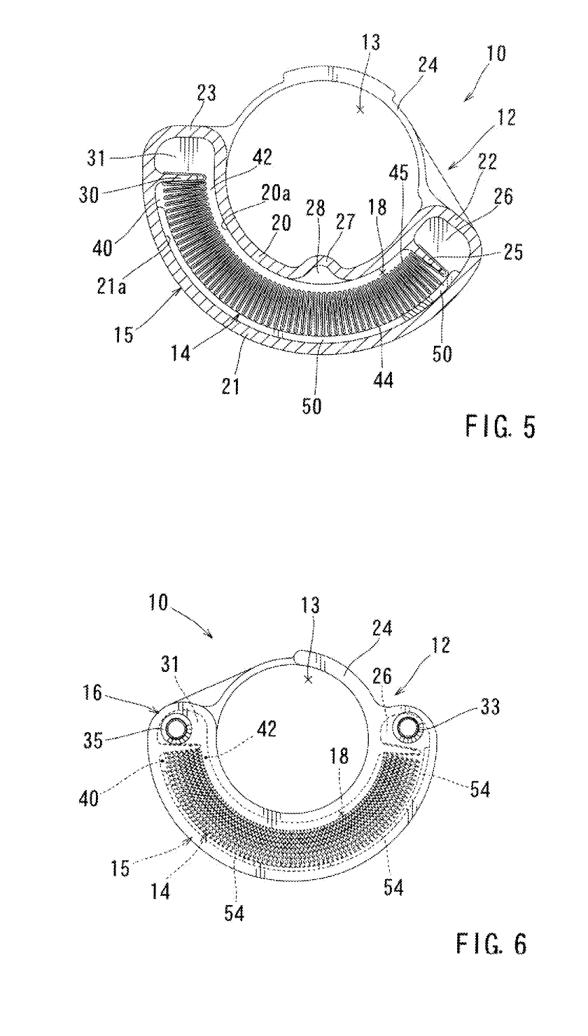

The next embodiment will be first described with reference to FIGS. 4 and 5. In this embodiment, the horizontal linear guide projection 47 of the first embodiment is replaced with two curved guide projections 50 that extend parallel with each other in the vertical direction. Each of the guide projection 50 is inclined such that its upstream side end (the end on the side of the fuel inlet region 26) is positioned at higher level that its downstream side end (the end on the side of the fuel storage region 31). In addition, each of the guide projections 50 has a gently curved arc-shaped configuration with its central portion concaved downward.

With this arrangement, the fuel that has flown into the fuel inlet region 26 flows toward the fuel storage region 31 through the first section 40 of the filtration chamber 18 along upper, middle and lower flow paths separated by the guide projections 50 as indicated by arrows 51Y in FIG. 4. At the end of the lower flow path, the flow of the fuel is turned upward as indicated by arrow 51Y in FIG. 4. Similarly, at the end of the middle flow path, the flow of the fuel is turned upward as indicated by arrow 52Y in FIG. 4. The upwardly turned flow of the fuel along the lower path and the upwardly turned flow of the fuel along the middle path converge with each other and further converge with the flow of the fuel along the upper path. Therefore, the guide projections 50 provide upper and lower detour routes 51 and 52 for the flow of the fuel from the fuel inlet side (i.e., the side of the fuel inlet region 26) to the fuel outlet side (i.e., the side of the fuel outlet region 28). The detour route 51 provides a flow of the fuel along the lower flow path below the guide projection 50 positioned on the lower side The detour route 52 provides a flow of the fuel along the middle flow path between the guide projections 50.

Also with this embodiment, substantially the same operation and advantages can be attained as with the last embodiment. In particular, because two guide projections 50 are provided in this embodiment, the fuel can further reliably flow along substantially the entire outer peripheral side 44 of the filter element 14 opposing to the first section 40. Therefore, the filtration performance can be further improved.

In addition, because each of the guide projection 50 is inclined such that its upstream side end (the end on the side of the fuel inlet region 26) is positioned at higher level that its downstream side end (the end on the side of the fuel storage region 31), the fuel flows gradually downward as it flows along the upper, middle and lower paths. Therefore, it is possible to reduce the resistance against flow of the fuel, which resistance may be caused by the guide projections 50. Furthermore, the lower path or the detour route 51 can effectively guide the fuel to the bottom at the circumferential end of the first section 40 on the side of the fuel storage region 31. Although two guide projections 50 are provided in this embodiment, three or more guide projections 50 can be provided.

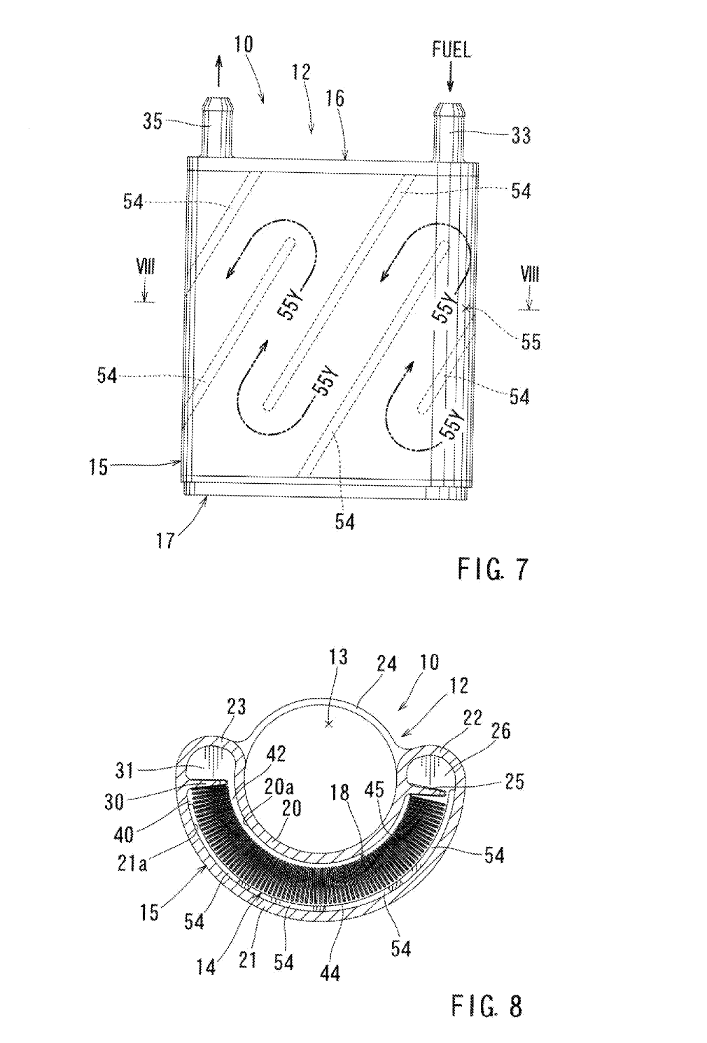

Another embodiment will now be described with reference to FIGS. 6 to 8. As shown in FIGS. 6 and 7, the fuel outlet portion 35 of the upper cover 16 is disposed to communicate with the fuel storage region 31 of the filtration chamber 18, so that the fuel storage region 31 also serves as a fuel outlet region. Therefore, in this embodiment, the fuel storage region 31 is also referred to as fuel outlet region 31. With this arrangement, the inlet region 26 and the outlet region 31 are disposed at opposite ends in the circumferential direction of the filtration chamber 18 as shown in FIG. 8. In this connection, the depression 27 (see FIG. 3) formed in the inner circumferential wall 20 of the case body 15 for defining the fuel outlet region 28 is not included.

In addition, the guide projection 47 (see FIG. 2) is replaced with guide projections 54 that extend parallel with each other. Each of the guide projections 54 is steeply inclined such that its upstream side end (the end on the side of the fuel inlet region 26) is positioned at higher level than its downstream side end (the end on the side of the fuel storage region 31). In addition, the guide projections 54 are disposed to be staggered with each other to provide a meandering path 55 for the flow of the fuel from the inlet region 26 to the circumferential end on the side of the outlet region 31 of the first section 40 of the filtration chamber 18 as indicated by arrows 55Y in FIG. 7.

Also with this embodiment, substantially the same operation and advantages can be attained as with the prior embodiments. In particular, because the fuel flows along the meandering path 55, the fuel can further reliably flow along substantially the entire outer peripheral side 44 of the filter element 14 opposing to the first section 40. Further, because no fuel can flow along the shortest path between the inlet portion 33 to the outlet portion 35 but the fuel must flow along the meandering path 55, the filtration performance can be further improved.

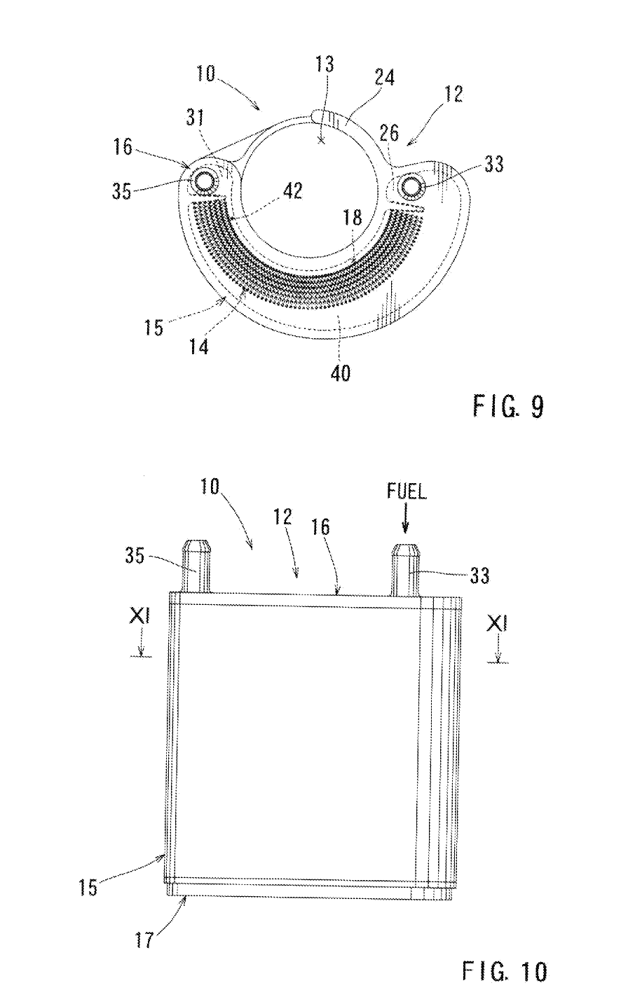

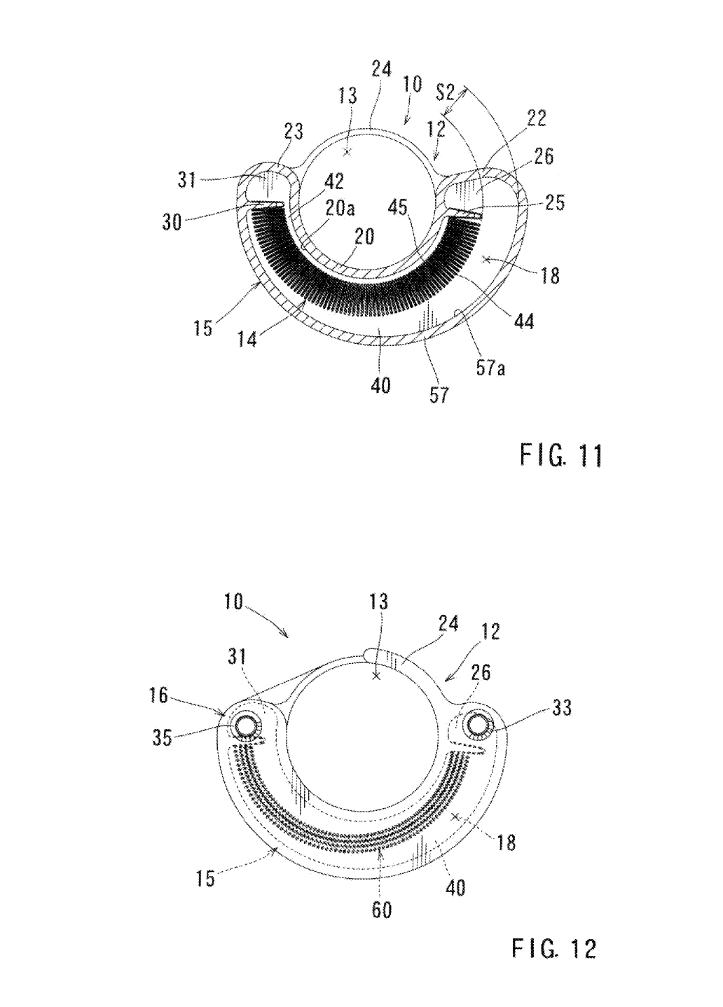

The next embodiment will now be described with reference to FIGS. 9 to 11. This embodiment is a modification of the last embodiment and is different fin that no guide projection 54 is provided and that the outer circumferential wall 21 of the case body 15 (see FIG. 8) is replaced with an outer circumferential wall 57. As shown in FIG. 11, the outer circumferential wall 57 extends gradually radially outward in the circumferential direction from the fuel outlet side (i.e., the side of the fuel outlet region 31) to the fuel inlet side (i.e., the side of the fuel inlet region 26). Therefore, the clearance S2 between the plane of the outer peripheral side 44 of the filter element 14 and the inner wall surface of the first section 40 of the filtration chamber I 8 or an inner wall surface 57a of the outer circumferential wall 57 gradually decreases toward the fuel outlet side (i.e., the side of the fuel outlet region 31).

According to this embodiment, the clearance S2 between the plane of the outer peripheral side 44 of the filter element 14 and the inner wall surface 57a of the outer circumferential wall 57 gradually decreases in the circumferential direction from the fuel inlet side (i.e., the side of the fuel inlet region 26) toward the fuel outlet side (i.e., the side of the fuel outlet region 31). As a result of this configuration, the loss of pressure of the fuel that passes through a portion of the filter element 14 on the fuel inlet side can be reduced. The fuel can flow along substantially the entire outer peripheral side 44 of the filter element 14 opposing to the first section 40. Further, it is possible to prevent the fuel from extensively passing through a portion of the filter 14 on the shortest route between the inlet portion 33 and the outlet portion 35. Thus, because the entire filtration area of the filter element 14 can be effectively used, the filtration performance can be improved and it is possible to improve the life of the fuel filter 10 and to reduce the size of the fuel filter 10.

Another embodiment will now be described with reference to FIGS. 12 to 14. Also, this embodiment is a modification of the third embodiment and is different from the third embodiment in that no guide projection 54 is provided and that the filter element 14 is replaced with a filter element 60. The filter element 60 has a uniform width 60W between a plane of an outer peripheral side 61 and a plane of an inner peripheral side 62. The width 60W is set to be substantially half the width of the filter element 14 of the last embodiment (see FIG. 8).

As shown in FIG. 14, one circumferential end of the filter element 60 is positioned adjacent to the base portion of the linear projection 25 of the inner circumferential wall 20 of the case body 15. On the other hand, the other circumferential end of the filter element 60 is positioned adjacent to the base portion of the linear projection 30 of the outer circumferential wall 21 of the case body 15. In other words, the one circumferential end of the filter element 60 is positioned adjacent to the inner circumferential wall 20, and the other circumferential end is positioned adjacent to the outer circumferential wall 21. Therefore, the filter element 60 extends diagonally within the filtration chamber 18. With this arrangement, the clearance S2 between the plane of the outer peripheral side 61 of the filter element 60 and the inner wall surface 21a of the first section 40 gradually decreases in a direction from the fuel inlet side (i.e., the side of the fuel inlet region 26) toward the fuel outlet side (i.e., the side of the fuel outlet region 31). On the contrary, the clearance S3 between the plane of the inner peripheral side 62 of the filter element 60 and the inner wall surface 20a of the second section 42 gradually increases in a direction from the fuel inlet side (i.e., the side of the fuel inlet region 26) toward the fuel outlet side (i.e., the side of the fuel outlet region 31).

According to this embodiment, the clearance S2 between the plane of the outer peripheral side 61 of the filter element 60 and the inner wall surface 21a of the first section 40 gradually decreases in the circumferential direction from the fuel inlet side (i.e., the side of the fuel inlet region 26) toward the fuel outlet side (i.e., the side of the fuel outlet region 31). Therefore, similar to the last embodiment, the loss of pressure of the fuel that passes through a portion of the filter element 60 on the fuel inlet side can be reduced. The fuel can flow along substantially the entire outer peripheral side 61 of the filter element 60. Further, it is possible to prevent the fuel from extensively passing through a portion of the filter element 60. Thus, because the entire filtration area of the filter element 60 can be effectively used, the filtration performance can be improved and it is possible to improve the life of the fuel filter 10 and to reduce the size of the fuel filter 10.

In addition, because the clearance S3 between the plane of the inner peripheral side 62 of the filter element 60 and the inner wall surface 20a of the second section 42 gradually increases in a direction from the fuel inlet side (i.e., the side of the fuel inlet region 26) toward the fuel outlet side (i.e., the side of the fuel outlet region 31), the fuel that has passed through substantially the entire filter element 60 can effectively smoothly flow toward the fuel outlet region 31.

Further, according to this embodiment, the filter element 60 is disposed diagonally within the filter chamber 18 of the filter case 12, which has a uniform clearance S1 between the inner wall surface 21a of the first section 40 and the inner wall surface 20a of the second section 42. Therefore, by using an existing filter case, it is possible to easily make the clearance S2 (between the plane of the outer peripheral side 61 of the filter element 60 and the inner wall surface 21a of the first section 40) to gradually decrease in a direction from the fuel inlet side toward the fuel outlet side and to make the clearance S3 between the plane of the inner peripheral side 62 of the filter element 60 and the inner wall surface 20a of the second section 42) to gradually increase in a direction from the fuel inlet side toward the fuel outlet side. It is not necessary to use a filter case that has a larger size.

The above embodiments may be modified in various ways. For example, the above embodiments can be combined with each other in various combinations including the followings:
(1) Combination of the embodiment in FIGS. 1-3 and the embodiment in FIGS. 9-11;
(2) Combination of the embodiment in FIGS. 1-3 and the embodiment in FIGS. 12-14;
(3) Combination of the embodiment in FIGS. 4-5 and the embodiment in FIGS. 9-11;
(4) Combination of the embodiment in FIGS. 4-5 and the embodiment in FIGS. 12-14;
(5) Combination of the embodiment in FIGS. 6-8 and the embodiment in FIGS. 9-11;
(6) Combination of the embodiment in FIGS. 6-8 and the embodiment in FIGS. 12-14.

Further, although the above embodiments have been described in connection with a fuel filter known as in-tank filters adapted to be disposed within a fuel tank, the present invention can also be applied to in-line type filters that are adapted to be disposed within a fuel pipeline outside of a fuel tank. The configurations of the filter case, the filtration chamber and the filter element may not be limited to the configurations disclosed in the above embodiments. Although the outer peripheral side of the filter element is set to be the fuel inlet side and the inner peripheral side is set to be the fuel outlet side in the above embodiments, the outer peripheral side may be set to be the fuel outlet side and the inner peripheral side may be set to be the fuel inlet side. Further, the guide projection(s) may he attached to either peripheral side of the filter element from which the fuel passes through and may be a separate member disposed between the outer circumferential wall and the filter element. The configuration of the guide projection(s) is not limited to a linear or curved configuration. For example, the guide projection may have a wave-like configuration, a wing-like configuration, a pin-like or a column-like configuration.

This invention claims:

1. A fuel filter comprising:
a filter case defining a filtration chamber with a fuel inlet and a fuel outlet;
a filter element for filtering the fuel, wherein the filter element is disposed within the filtration chamber and divides the filtration chamber into a first section on the side of the fuel outlet and a second section on the side of the fuel outlet;
wherein the filter element has a first side opposing to the first section and a second side opposing to the second section;
a guide device disposed within the first section and arranged and constructed to provide a flow of the fuel within the first section along substantially the entire filter element.

2. The fuel filter as in claim 1, wherein the guide device comprises a guide projection extending from an inner wall surface of the first section, the inner wall surface is spaced from the first side of the filter element by a first distance.

3. The fuel filter as in claim 2, wherein the guide projection is configured to provide a detour path for the flow of the fuel from the fuel inlet side to the fuel outlet side.

4. The fuel filter as in claim 2, wherein the guide projection is configured to provide a meandering path for the flow of the fuel from the fuel inlet side to the fuel outlet side.

5. The fuel filter as in claim 1 wherein the first section has an inner wall spaced from the first side of the filter element by a first distance, wherein the size of the first distance on the fuel outlet side is smaller than the size of the first distance on the fuel inlet side.

6. The fuel filter as in claim 2 wherein the size of the first distance on the fuel outlet side is smaller than the first distance on the fuel inlet side.

7. The fuel filter as in claim 5 wherein the second section has an inner wall spaced from the second side of the filter element by a second distance, wherein the size of the second distance on the fuel outlet side is greater than the size of the second distance on the fuel inlet side.

8. The fuel filter as in claim 6 wherein the second section has an inner wall spaced from the second side of the filter element by a second distance, wherein the size of the second distance on the fuel outlet side is greater than the size of the second distance on the fuel inlet side.

9. A fuel filter comprising.
a filter case defining a filtration chamber with a fuel inlet and a fuel outlet;
a filter element for filtering the fuel, wherein the filter element is disposed within the filtration chamber and divides the filtration chamber into a first section on the side of the fuel outlet and a second section on the side of the fuel outlet;
wherein the filter element has a first side opposing to the first section and a second side opposing to the second section;
wherein the first section has an inner wall spaced from the first side of the filter element by a first distance, wherein the size of the first distance on the fuel outlet side is smaller than the size of the first distance on the fuel inlet side.

10. The fuel filter as in claim 9 wherein the second section has an inner wall spaced from the second side of the filter element by a second distance, wherein the size of the second distance on the fuel outlet side is greater than the size of the second distance on the fuel inlet side.

11. The fuel filter as in claim 10, wherein the filtration chamber has a first width between the inner wall of the first section and the inner wall of the second section, the first width is substantially uniform between the fuel inlet side and the fuel outlet side, and wherein the filter element has a second width between the first side and the second side, and wherein the second width is substantially uniform between the fuel inlet side and the fuel outlet side.

12. A fuel filter comprising:
a filter case defining a filtration chamber with a fuel inlet and a fuel outlet;
a filter element for filtering the fuel, wherein the filter element is disposed within the filtration chamber and divides the filtration chamber into a first section on the side of the fuel outlet and a second section on the side of the fuel outlet; and
a control device arranged and constructed to control the flow of the fuel within the first section, so that the fuel cannot flow directly from the fuel inlet to the fuel outlet.

13. The fuel filter as in claim 12, wherein the control device comprises at least one control member disposed within the first section, the at least one control member controls a flow path of the fuel within the first section, so that the flow path is longer than a shortest distance between the fuel inlet side and the fuel outlet side within the first section.

14. The fuel filter as in claim 12, wherein the control device is arranged and constructed to control the cross sectional area of the first section such that the cross sectional area of the first section on the side of the fuel outlet side is smaller than the cross sectional area on the fuel inlet side.

15. The fuel filter as in claim 12, wherein the filtration chamber includes an inner wall and an outer wall, further wherein the control device is a plurality of projections that extend from the outer wall.

16. The fuel filter as in claim 15, wherein the plurality of projections are coaxial with the inner wall.

17. The fuel filter as in claim 15, wherein the inner and outer wall each extend from a top of the filtration chamber and a bottom of the filtration chamber.

18. The fuel filter as in claim 17, wherein the plurality of projections extend diagonally from the top to the bottom.

19. The fuel filter as in claim 17, wherein the plurality of projections extend in a curved diagonal configuration from the top to the bottom.

20. The fuel filter as in claim 15, wherein the plurality of projections have a curved arc shape configuration.
